(19) United States
(12) Patent Application Publication
(10) Pub. No.: US 2008/0319126 A1
(43) Pub. Date: Dec. 25, 2008

(54) Polyolefin waxes as phase change material (PCM) for use as latent heat store

(75) Inventors: Rainer Fell, Gersthofen (DE); Hermann Diem, Wehringen (DE); Peter Staniek, Binzen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/214,753

(22) Filed: Jun. 20, 2008

(30) Foreign Application Priority Data
Jun. 20, 2007 (DE) 10 2007 028 309.3

(51) Int. Cl. C08F 10/02; C08F 10/06; C08F 4/06; C08F 210/06; C08L 23/12; C08L 23/06

(52) U.S. Cl. 524/584; 526/351; 526/352; 524/570; 526/348; 524/582; 524/585; 524/586

(57) ABSTRACT

Latent heat store based on an organic material which melts at a temperature in the range from 80 to 160° C. and comprises one or more polyolefin waxes which have been prepared via a metallocene-catalyzed reaction.

The polyolefin waxes are preferably present as powder, granules or block in the material and are homopolymers of ethylene or of propylene or copolymers of propylene with ethylene or copolymers of ethylene with propylene or with one or more 1-olefins. The material has an enthalpy of fusion in the range from 70 to 280 J/g.

The present invention is described in the German priority application No. 102007028309.3, filed 06.20.2007, which is hereby incorporated by reference as is fully disclosed herein.

The present invention relates to the use of polyolefin waxes, in particular Licocene® Performance Polymer, as phase change material for use as latent heat store.

Phase change materials (PCMs) are referred to as latent heat stores and utilize the enthalpy of fusion during the change in stage (phase transition) of a material/phase change material (e.g. solid-liquid) for the storage of energy (heat). For the purposes of the present invention, latent heat storage is the storage of heat in a material (phase change material) which experiences a phase change, predominantly solid-liquid. Apart from the solid-liquid phase change, it is also possible in principle to use solid-solid phase changes. However, these generally display far lower storage densities. In the storage of energy (heat) in the store, the material begins to melt on reaching the temperature of the phase change. Despite further storage of energy (heat), the temperature does not increase. Only when the material is completely molten does an increase in temperature again occur. Since no appreciable temperature increase occurs for a prolonged period despite introduction of energy, the energy stored during the phase change is referred to as “hidden heat” or “latent heat”.

The effect of latent heat results in two advantages:
it is possible to store relatively large quantities of heat in a region of small temperature changes and thus achieve high storage densities;
since the phase change proceeds at constant temperature over some period of time, it is possible to smooth out temperature fluctuations and minimize temperature peaks.

The selection criteria for materials as PCM are as follows:
chemical and physical stability against external influences
suitable temperature of the phase change (change in state)
low corrosivity
low supercooling
small volume change
low vapor pressure
high enthalpy of fusion and high heat capacity
high storage density
very high thermal conductivity
reproducible phase change

Materials/phase change materials as latent heat stores can be used in a particular temperature range. Depending on the application and use, the material has to be chosen so as to have a suitable temperature of the phase change. Depending on the temperature range, various groups of materials are used. Typical groups of materials which can be used as PCM and their use temperatures are:
gas hydrates (about 0° C. to 20° C.),
paraffins (about 0° C. to 110° C.) in microencapsulated or macroencapsulated form
HDPE (high density polyethylene)
salts and their eutectic mixtures (about >150° C.)
salt hydrates and their mixtures (about 0° C. to 130° C.),
salt-water eutectics (about −100° C. to 0° C.),
water,
sugar alcohols (about 50° C. to 170° C.).

For “storage of cold” at low temperatures (about 0° C.), water or aqueous salt solutions are used. For the storage of heat in the temperature range from about 5° C. to 100° C., paraffins are predominantly used, while salt hydrates and their eutectic mixtures are used for the range from 5° C. to 150° C. For storage of heat in the temperature range above about 150° C., salts and their eutectic mixtures are used.

Typical constructions or functional concepts of latent heat stores which are already used in industry can be:
latent heat stores having plate heat transfer
latent heat stores in which PCM and heat transfer fluid are in direct contact
latent heat stores with shell-and-tube heat transfer
latent heat stores having heat transfer fluid and PCM elements.

Typical fields of use of latent heat stores are:
general refrigeration and air conditioning engineering
replacement of hot water stores in conventional heat systems
building construction
clothing
solar and air systems
storage of process heat
overheating protection for components and in the case of fire
slowing of cooling in high-temperature processes
buffering of temperature-sensitive goods against heat or cold.

In addition, the patents DE 199 02 990 A1; U.S. Pat. No. 4,908,166; DE 199 29 861 and DE 102 00316 are cited as prior art.

PCMs can only be used successfully when their properties do not change in an adverse way on prolonged use and the temperature behavior of the materials used as PCM are matched to the temperatures of the heat transfer media.

The higher the enthalpy of fusion and the higher the heat capacity of a material, the better is this material as PCM.

In the temperature range from 0 to 110° C., it is usual to use paraffins which comprise mixtures of long-chain hydrocarbons. When paraffins are used as PCM, there are hardly any technical problems since this material consists of only one group of substances and does not contain any solvents. It is not possible for materials to separate.

Important prerequisites such as a reproducible phase change, toxicological acceptability and inert behavior toward other materials/phase change materials (no corrosion of metals) are ensured in this way. Disadvantages of paraffins are the comparatively low enthalpies of fusion of up to about 200 J/g at densities of from about 0.7 to 0.9 kg/dm³ and also the low thermal conductivity of about 0.5 W/m*K).

For the temperature range from 5 to 150° C., salt hydrates are preferred over paraffins and aqueous salt solutions. The enthalpies of fusion differ only slightly from those of paraffins, but they have higher densities in the range from about 1.4 to 1.6 kg/dm³. This increases their energy density.

Disadvantages of salt hydrates are the comparatively low enthalpies of fusion of about 200 J/g and the usually incongruent melting behavior and the separation of the molten products due to the different densities. Solidification of the substances usually occurs only incompletely. In addition, salt hydrates are usually corrosive toward metals.

It was therefore an object of the present invention to provide materials as PCM for use as latent heat stores in the temperature range from 0 to 180° C., which have relatively high enthalpies of fusion, high thermal conductivities and relatively high energy (heat) charging and discharge cycles and do not display the disadvantages mentioned, e.g. low enthalpy of fusion, high corrosivity, supercooling, high volume change, vapor pressure, low heat capacity, low storage density, irreproducible phase change and toxicological concerns and also phase separation.

The latent heat should arise in the range from 80 to 160° C.

The present invention achieves this object and provides latent heat stores based on an organic material which melts at a temperature in the range from 80 to 160° C. and comprises one or more polyolefin waxes which have been prepared via a metallocene-catalyzed reaction.

The material of the invention contains the polyolefin wax or waxes as powder, granules or block and displays an enthalpy of fusion in the range from 70 to 280 J/g.

The polyolefins present in the material/phase change material of the invention are polyolefin waxes which are preferably prepared from homopolymers of ethylene or of propylene or copolymers of propylene with ethylene or copolymers of ethylene with propylene or with one or more 1-olefins.

Particularly advantageous properties are found when the material is a wax which is prepared from olefins, preferably from ethylene or propylene, particularly preferably from ethylene, by polymerization in the presence of metallocene as catalyst.

The synthesis of the metallocene polyolefin waxes can be carried out under a pressure of from 0.1 to 10 MPa in the gas phase or in suspension or in solution in a suitable suspension medium/solvent using known technologies.

Metallocene catalysts for preparing the polyolefin waxes are chiral or achiral transition metal compounds of the formula M¹Lₓ. The transition metal compound M¹Lₓ contains at least one central metal atom M¹ to which at least one π-ligand, e.g. a cyclopentadienyl ligand, is bound. In addition, substituents such as halogen, alkyl, alkoxy or aryl groups can be bound to the central metal atom M¹. M¹ is preferably an element of main group III, IV, V or VI of the Periodic Table of the Elements, e.g. Ti, Zr or Hf. For the purposes of the present invention, cyclopentadienyl ligands are unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl and octahydrofluorenyl radicals. The π-ligands can be bridged or unbridged, with single and multiple bridges, including via ring systems, being possible. The term metallocene also encompasses compounds having more than one metallocene fragment, known as multinuclear metallocenes. These can have any substitution pattern and bridging variants. The individual metallocene fragments of such multinuclear metallocenes can be identical or different. Examples of such multinuclear metallocenes are described, for example, in EP-A-632063.

Examples of general structural formulae of metallocenes and of their activation by means of a cocatalyst are given, inter alia, in EP-A-571882.

The material of the invention, which comprises powder or granules of metallocene-catalyzed polyolefin waxes, surprisingly has very high enthalpies of fusion of up to 280 J/g in the melting point range from about 80 to 160° C. Preference is given to using metallocene-catalyzed polyolefin waxes which have an enthalpy of fusion of from 70 to 270 J/g and dropping points of from 100 to 150° C. Particular preference is given to metallocene-catalyzed polyolefin waxes having an enthalpy of fusion of from 200 to 270 J/g and dropping points of from 110 to 145° C. The densities of the materials vary in the range from 0.89 to 0.98 kg/dm³.

Since the polyolefin present in the material of the invention does not contain any reactive chemical groups, it is chemically inert so that no chemical reaction with commercial materials such as metals and plastics takes place, which is a requirement in the design of the latent heat stores.

In use as latent heat store, the material displays very good compatibility with paraffins and polyolefins, which has the advantage that latent heat stores comprising mixtures of components such as metallocene-catalyzed polyolefin waxes, paraffins and polyolefins (e.g. high density polyethylenes=HDPE) can be used. Mixing ratios of up to 50% of paraffin and/or polyolefins (HDPE) are quite conceivable.

In addition, additives (heat stabilizers, antioxidants, light stabilizers) can be present to increase the cycling stability of a latent heat store and to prolong its life. The proportion of additives can be in the range from 0 to 20%, preferably from 0 to 5%.

Furthermore, additives for increasing the thermal conductivity, for example metal (metal powder or metal threads) or pure carbon (graphite powder or graphite flocks) can be present. The proportion of such additives for increasing the thermal conductivity can be up to 50%, preferably from 0 to 30%.

The material of the invention as PCM for use in latent heat storage systems is present as granules, powder or block and can be shaped to form plates, profiles, three-dimensional bodies without problems.

Suitable polyolefin waxes are, in particular, Licocene® Performance Polymers from Clariant, which have a very high enthalpy of fusion density (from 70 to 280 J/g at densities of from 0.9 kg/dm³ to 0.97 kg/dm³). The melting points of these polymers are in the range from 80 to 160° C.

In particular, one or more of the following products from Clariant: TP Licocene® PE 3401, TP Licocene® PE 4201, TP Licocene® PE 5301 and/or TP Licocene® PP 6102 are used as polyolefin waxes.

In addition, Licocene® Performance Polymers are toxicologically acceptable, chemically inert, display no demixing, are not hazardous materials and have a reproducible phase change (solid-liquid).

### EXAMPLES

The invention is illustrated by the following examples without being restricted thereto. Examples of metallocene polyolefin waxes which can advantageously be used either individually or as mixtures in powder form as PCM for latent heat stores according to the invention presented here are:

Metallocene PE waxes:
TP Licocene® PE 3401
TP Licocene® PE 4201
TP Licocene® PE 5301
TP Licocene® PP 6102

The manufacturer of the abovementioned waxes is Clariant Produkte (Deutschland) GmbH.

### Example 1

DSC (differential scanning calorimetry) measurements were carried out on TP Licocenes®. The following enthalpies of fusion were determined:

| | Enthalpy of | Dropping | |
|---|---|---|---|
| | fusion [J/g] | point [° C.] | Density [kg/dm³] |
| TP Licocene ® PE 3401 | 170 | 114 | 0.93 |
| TP Licocene ® PE 4201 | 260 | 128 | 0.97 |
| Licocene ® PE 5301 | 260 | 130 | 0.97 |
| TP Licocene ® PP 6102 | 70 | 145 | 0.90 |

When cyclic heating (melting) and cyclic cooling (solidification) was carried out, it was found that the phase change is stable and reproducible. The material according to the invention was neither degraded thermally nor underwent decomposition.

1. A latent heat store based on an organic material which melts at a temperature in the range from 80 to 160° C. comprising one or more polyolefin waxes which have been prepared via a metallocene-catalyzed reaction.

2. The latent heat store as claimed in claim 1, wherein the one or more polyolefin waxes are present as powder, granules or block in the organic material.

3. The latent heat store as claimed in claim 1, wherein the one or more polyolefin waxes are homopolymers of ethylene or of propylene of copolymers of propylene with ethylene or copolymers of ethylene with propylene or with one or more 1-olefins.

4. The latent heat store as claimed in claim 1, wherein the organic material has an enthalpy of fusion in the range from 70 to 280 J/g.

5. The latent heat store as claimed in claim 1, wherein one or more polyolefin waxes having an enthalpy of fusion of from 70 to 270 J/g and dropping points of from 100 to 150° C. are used.

6. The latent heat store as claimed in claim 1, wherein one or more polyolefin waxes having enthalpies of fusion of from 200 to 270 J/g and dropping points of from 110 to 145° C. are used.

7. The latent heat store as claimed in claim 1, wherein the latent heat store additionally contains one ore more additives selected from the group consisting of: heat stabilizers, antioxidants, light stabilizers, metal and carbon.

8. The latent heat store as claimed in claim 1, wherein the one or more polyolefin waxes are selected from the group consisting of TP Licocene® PE 3401, TP Licocene® PE 4201, TP Licocene® PE 5301, TP Licocene® PP 6102 and mixtures thereof.

9. A latent heat store comprising one or more polyolefin waxes prepared via a metallocene-catalyzed reaction and have an enthalpy of fusion in the range from 70 to 280 J/g.
